(19) United States
(12) Patent Application Publication
(10) Pub. No.: US 2023/0021886 A1
(43) Pub. Date: Jan. 26, 2023

(54) METHOD AND DEVICE FOR FORWARDING PRIORITY TAG ACROSS NETWORK SEGMENTS

(71) Applicant: INSPUR SUZHOU INTELLIGENT TECHNOLOGY CO., LTD., Suzhou, Jiangsu (CN)

(72) Inventors: Fuli YUAN, Suzhou, Jiangsu (CN); Dexin LI, Suzhou, Jiangsu (CN)

(21) Appl. No.: 17/786,778

(22) PCT Filed: Aug. 26, 2020
(86) PCT No.: PCT/CN2020/111231

§ 371 Date: Aug. 4, 2022

(30) Foreign Application Priority Data
Dec. 17, 2019 (CN) 201911297742.4

(51) Int. Cl. H04L 47/2425; H04L 12/46; H04L 45/302; H04L 45/50; H04L 45/00

(52) U.S. Cl. CPC H04L 47/2433; H04L 12/4666; H04L 45/306; H04L 45/50; H04L 45/66

(57) ABSTRACT

The present disclosure provides a method and device for forwarding a priority tag across network segments. The method includes the following steps: performing networking by using a Virtual Local Area Network (VLAN) interface to form a network; enabling a VLAN Class Of Service (COS) and differentiated service code point in a priority tag of a message transmitted in the network to correspond to each other; in response to layer-3 forwarding of the message, using the differentiated service code point priority tag for the message, and copying a VLAN COS value of the message at an entry of a switch to a VLAN COS value of the message at an exit; and in response to subsequent layer-2 forwarding of the message, using the VLAN COS priority tag for the message to distinguish a priority of the message.

This application claims priority to Chinese Patent Application No. 201911297742.4, filed on Dec. 17, 2019, in China National Intellectual Property Administration and entitled “Method and Device for Forwarding Priority Tag Across Network Segments”, the contents of which are hereby incorporated by reference in its entirety.

### FIELD

The present disclosure relates to the field of computers, and more particularly to a method and device for forwarding a priority tag across network segments.

### BACKGROUND

All data flows are processed relatively well in case of abundant network bandwidth, while may be discarded in case of network congestion. Quality of service may ensure that different priorities are provided for each flow to identify relative importance thereof. In a conventional Internet Protocol (IP) network, bearing a quality of service priority tag in an IP version 4 (IPv4) message mainly uses a Class Of Service (COS) field in a Virtual Local Area Network (VLAN) is used for identification in layer-2 transmission, and uses a differentiated service code point field priority or a Type Of Service (TOS) priority in cross-network-segment layer-3 transmission. At present, TOS in IP networks is basically no longer used. Layer 2 transmission uses COS, and cross-network-segment transmission uses the differentiated service code point field. Original layer-2/3 quality of service transmission uses a single priority bearer tag (COS or differentiated service code point), which is not so flexible and cannot meet requirements for meticulous and flexible service for different types of flows.

### SUMMARY

In view of this, an objective of embodiments of the present disclosure is to provide a method and device for forwarding a priority tag across network segments. By the method, network resources may be well used, and after a message passes through a layer-3 forwarding device, a COS and a differentiated service code point may still be used for providing service with high quality of service to a client. The method has the advantages such as a simple networking scheme and high stability.

Based on the above objective, an aspect of the embodiments of the present disclosure provides a method for forwarding a priority tag across network segments, including the following steps:

performing networking by using a Virtual Local Area Network (VLAN) interface to form a network;

enabling a VLAN COS and differentiated service code point in a priority tag of a message transmitted in the network to correspond to each other;

in response to layer-3 forwarding of the message, using the differentiated service code point priority tag for the message, and copying a VLAN COS value of the message at an entry of a switch to a VLAN COS value of the message at an exit;

in response to subsequent layer-2 forwarding of the message, using the VLAN COS priority tag for the message to distinguish a priority of the message.

According to an embodiment of the present disclosure, the enabling a VLAN COS and differentiated service code point in a priority tag of a message transmitted in the network to correspond to each other includes:

enabling fields 0 to 7 of the VLAN COS to correspond to fields 0 to 63 of the differentiated service code point respectively, wherein one field of the VLAN COS corresponds to eight fields of the differentiated service code point.

According to an embodiment of the present disclosure, fields of the VLAN COS and the differentiated service code point increase with increase of a priority of service of quality in the message.

According to an embodiment of the present disclosure, the performing networking by using a VLAN interface includes:

performing networking in a convergence layer and core layer of an enterprise by using the VLAN interface.

According to an embodiment of the present disclosure, the message contains a VLAN tag when sent out by the VLAN interface.

Another aspect of the embodiments of the present disclosure also provides a device for forwarding a priority tag across network segments, characterized by including:

at least one processor; and

a memory, storing a program code operable for the processor. The program code is operated by the processor to execute the following steps:

enabling a VLAN COS and differentiated service code point in a priority tag of a message transmitted in a network formed by performing networking by using a VLAN interface to correspond to each other;

in response to layer-3 forwarding of the message, using the differentiated service code point priority tag for the message, and copying a VLAN COS value of the message at an entry of a switch to a VLAN COS value of the message at an exit;

in response to subsequent layer-2 forwarding of the message, using the VLAN COS priority tag for the message to distinguish a priority of the message.

According to an embodiment of the present disclosure, the enabling a VLAN COS and differentiated service code point in a priority tag of a message transmitted in the network to correspond to each other includes:

enabling fields 0 to 7 of the VLAN COS to correspond to fields 0 to 63 of the differentiated service code point respectively, wherein one field of the VLAN COS corresponds to eight fields of the differentiated service code point.

According to an embodiment of the present disclosure, fields of the VLAN COS and the differentiated service code point increase with increase of a priority of service of quality in the message.

According to an embodiment of the present disclosure, the performing networking by using a VLAN interface includes:

performing networking in a convergence layer and core layer of an enterprise by using the VLAN interface.

According to an embodiment of the present disclosure, the message contains a VLAN tag when sent out by the VLAN interface.

The present disclosure has the following beneficial technical effects. According to the method for forwarding a priority tag across network segments in the embodiments of the present disclosure, networking is performed by using a VLAN interface to form a network; a VLAN COS and differentiated service code point in a priority tag of a message transmitted in the network are enabled to correspond to each other; in response to layer-3 forwarding of the message, the differentiated service code point priority tag is used for the message, and a VLAN COS value of the message at an entry of a switch is copied to a VLAN COS value of the message at an exit; and in response to subsequent layer-2 forwarding of the message, the VLAN COS priority tag is used for the message to distinguish a priority of the message. With adoption of such a technical solution, network resources may be well used, and after the message passes through a layer-3 forwarding device, the COS and the differentiated service code point may still be used for providing service with high quality of service to a client. The method has the advantages such as simple networking scheme and high stability.

### BRIEF DESCRIPTION OF THE DRAWINGS

In order to more clearly illustrate the technical solutions in the embodiments of the present invention or the prior art, the drawings needing to be used in the description of the embodiments or the prior art will be briefly introduced below. It is obvious that the drawings in the following description are merely some embodiments of the present invention, and a person of ordinary skill in the art may also obtain other embodiments according to these drawings without involving any inventive effort.

FIG. 1 is a schematic flowchart of a method for forwarding a priority tag across network segments according to an embodiment of the present disclosure;

FIG. 2 is a schematic diagram of a network structure according to an embodiment of the present disclosure.

### DETAILED DESCRIPTION

In order to make the objective, technical solutions, and advantages of the present disclosure clearer, the embodiments of the present disclosure will further be described below in detail in combination with specific embodiments and with reference to the drawings.

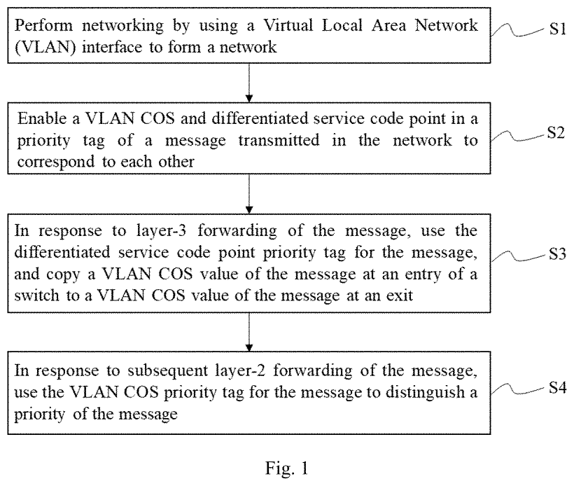

Based on the above objective, a first aspect of the embodiments of the present disclosure discloses an embodiment of a method for forwarding a priority tag across network segments. FIG. 1 is a schematic flowchart of the method.

As shown in FIG. 1, the method may include the following steps.

S1: perform networking by using a Virtual Local Area Network (VLAN) interface to form a network.

S2: enable a VLAN COS and differentiated service code point in a priority tag of a message transmitted in the network to correspond to each other, and enable a VLAN COS for layer-2 transmission to correspond to a differentiated service code point for layer-3 transmission such that a priority of quality of service in the message remains consistent during layer-2 or layer-3 transmission.

S3: in response to layer-3 forwarding of the message, use the differentiated service code point priority tag for the message, and copy a VLAN COS value of the message at an entry of a switch to a VLAN COS value of the message at an exit. With the use of the VLAN interface, the message may contain a VLAN tag when sent out. A VLAN COS field in the message received at an entry of a switch is copied to a VLAN COS field at an exit. Meanwhile, a differentiated service code point value in an IP header in cross-network-segment transmission remains unchanged. Therefore, for the message forwarded from the exit, not only is cross-VLAN transmission implemented, but also a COS field in a layer-2 VLAN and a differentiated service code point field in the IP header are retained.

S4: in response to subsequent layer-2 forwarding of the message, use the VLAN COS priority tag for the message to distinguish a priority of the message.

The method provided by the present disclosure makes better use of the conventional network technology, and layer-3 traffic may bear a COS tag of a layer-2 VLAN and a differentiated service code point priority tag of a layer-3 IP header. Therefore, during cross-network-segment transmission, data traffic containing COS and differentiated service code point priority tags may ensure quality of service for a superior group, enterprise, or personal user better.

Through the above technical solution, network resources may be well used, and after the message passes through a layer-3 forwarding device, the COS and the differentiated service code point may still be used for providing service with high quality of service to a client. The method has the advantages such as simple networking scheme and high stability.

In a preferred embodiment of the present disclosure, the operation that a VLAN COS and differentiated service code point in a priority tag of a message transmitted in the network are enabled to correspond to each other includes that:

enabling fields 0 to 7 of the VLAN COS to correspond to fields 0 to 63 of the differentiated service code point respectively, wherein one field of the VLAN COS corresponds to eight fields of the differentiated service code point.

Specifically, field 0 of the VLAN COS corresponds to fields 0 to 7 of the differentiated service code point, field 1 of the VLAN COS corresponds to fields 8 to 15 of the differentiated service code point, field 2 of the VLAN COS corresponds to fields 16 to 23 of the differentiated service code point, field 3 of the VLAN COS corresponds to fields 24 to 31 of the differentiated service code point, field 4 of the VLAN COS corresponds to fields 32 to 39 of the differentiated service code point, field 5 of the VLAN COS corresponds to fields 40 to 47 of the differentiated service code point, field 6 of the VLAN COS corresponds to fields 48 to 55 of the differentiated service code point, and field 7 of the VLAN COS corresponds to fields 56 to 63 of the differentiated service code point. Therefore, the priority of the quality of service in the message remains consistent during layer-2 or layer-3 transmission.

In a preferred embodiment of the present disclosure, fields of the VLAN COS and the differentiated service code point increase with increase of a priority of service of quality in the message. For example, when several messages are transmitted at the same time, a COS field of a message with a high priority is 6, and a COS field of a message with a low priority is 3.

In a preferred embodiment of the present disclosure, the operation that networking is performed by using a VLAN interface includes that:

performing networking in a convergence layer and core layer of an enterprise by using the VLAN interface.

In a preferred embodiment of the present disclosure, the message contains a VLAN tag when sent out by the VLAN interface.

### Embodiments

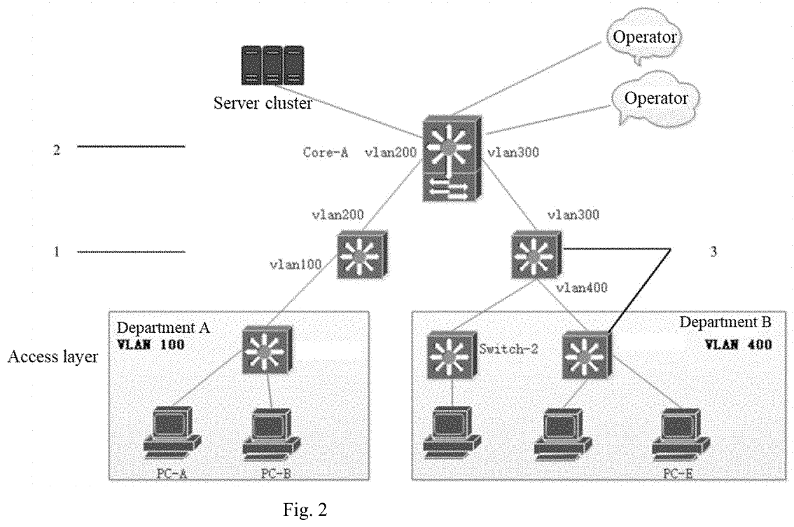

The method may be implemented by a network structure shown in FIG. 2 through the following process.

Traffic forwarding is needed by communication between department A and department B (for example, between each of PC-A and PC-B, and PC-E). A priority of PC-A is highest. Therefore, fields of a VLAN COS and differentiated service code point of a message in traffic sent out by PC-A are larger than those of a VLAN COS and differentiated service code point of the message in traffic sent out by PC-B. Due to cross-VLAN cross-IP-segment layer-3 forwarding, in a conventional traffic forwarding process, if a quality of service priority tag born in the traffic only includes the differentiated service code point or TOS field of the IP message after the traffic passes through a layer-3 forwarding device, service about the quality of service may be implemented by use of a differentiated service code point priority tag during layer-3 forwarding of the traffic in a convergence layer 1 and a core layer 2. However, when the traffic passes through the layer-3 device and enters a certain big layer-2 network, such as a VLAN where department B is located, it is impossible to implement service about the quality of service because the differentiated service code point does not work for layer-2 forwarding.

During the construction of the layer-3 network shown in the figure, a VLAN interface is used, service about the quality of service is implemented by use of the differentiated service code point priority tag during layer-3 forwarding in the convergence layer 1 and the core layer 2, and meanwhile, a VLAN COS value of the message at an entry of each switch 3 is copied to a VLAN COS value of the message at an exit. As such, during cross-department cross-IP-segment transmission, although a VLAN tag may change, the COS value may remain unchanged during forwarding. During cross-VLAN layer-3 forwarding, service about the quality of service is provided by the differentiated service code point priority tag in the IP message. When the traffic enters the big layer-2 network where department B is located, the original COS value may still be used to distinguish a high-priority service flow. The method is easy to implement, and an existing quality of service protocol may be used better.

Through the above technical solution, network resources may be well used, and after the message passes through a layer-3 forwarding device, the COS and the differentiated service code point may still be used for providing service with high quality of service to a client. The method has the advantages such as simple networking scheme and high stability.

It should be noted that those skilled in the art will appreciate that all or part of the processes in the methods of the above-mentioned embodiments can be completed by instructing relevant hardware through computer-readable instructions or a program, and the computer-readable instructions or program may be stored in a computer-readable storage medium which, when executed, may cause a processor to perform the processes of the embodiments of the methods described above. The memory medium may be a magnetic disk, an optical disk, a Read-Only Memory (ROM), a Random Access Memory (RAM), or the like. The embodiment of the computer program may have effects the same as or similar to those in any corresponding method embodiment.

In addition, the method disclosed according to the embodiments of the present disclosure may also be implemented as a computer program executed by a Central Processing Unit (CPU). The computer program may be stored in a computer-readable memory medium. When the computer program is executed by the CPU, the functions defined in the method disclosed in the embodiments of the present disclosure are executed.

Based on the above objective, a second aspect of the embodiments of the present disclosure discloses a device for forwarding a priority tag across network segments, characterized by including:

at least one processor; and

a memory, having a program code executable by the processor stored thereon, which when executed, implements the following steps:

enabling a VLAN COS and differentiated service code point in a priority tag of a message transmitted in a network formed by performing networking by using a VLAN interface to correspond to each other;

in response to layer-3 forwarding of the message, using the differentiated service code point priority tag for the message, and copying a VLAN COS value of the message at an entry of a switch to a VLAN COS value of the message at an exit;

in response to subsequent layer-2 forwarding of the message, using the VLAN COS priority tag for the message to distinguish a priority of the message.

In a preferred embodiment of the present disclosure, the operation that a VLAN COS and differentiated service code point in a priority tag of a message transmitted in the network are enabled to correspond to each other includes that:

enabling fields 0 to 7 of the VLAN COS to correspond to fields 0 to 63 of the differentiated service code point respectively, wherein one field of the VLAN COS corresponds to eight fields of the differentiated service code point.

In a preferred embodiment of the present disclosure, fields of the VLAN COS and the differentiated service code point increase with increase of a priority of service of quality in the message.

In a preferred embodiment of the present disclosure, the operation that networking is performed by using a VLAN interface includes that:

performing networking in a convergence layer and core layer of an enterprise by using the VLAN interface.

In a preferred embodiment of the present disclosure, the message contains a VLAN tag when sent out by the VLAN interface.

It is to be particularly pointed out that a working process of each module is described in the above-mentioned system embodiment with the above-mentioned method embodiment, and application of these modules to other embodiments of the method is apparent to those skilled in the art.

Moreover, each method step and system unit or module may also be implemented by a controller and a computer-readable memory medium configured to store a computer program enabling the controller to implement the steps or functions of the units or modules.

It is also understood by those skilled in the art that various exemplary logic blocks, modules, circuits, and algorithm steps described in combination with the present disclosure herein may be implemented as electronic hardware, computer software, or a combination thereof. For ease of description about such interchangeability of hardware and software, functions of various schematic components, blocks, modules, circuits, and steps are described generally. Whether these functions are implemented as software or hardware depends on specific applications and design constraints on the whole system. Those skilled in the art may realize the functions for each specific application in various manners, but such realization should not be explained as resulting in departure from the scope disclosed in the embodiment of the present disclosure.

The above-mentioned embodiment, particularly any “preferred” embodiment, is a possible example of implementation only for understanding the principle of the present disclosure clearly. Various variations and modifications may be made to the above-mentioned embodiment without departing from the spirit and principle of the technology described herein. It is intended that all modifications be included in the scope of present disclosure and protected by the appended claims.

1. A method for forwarding a priority tag across network segments, comprising the following steps:
performing networking by using a Virtual Local Area Network (VLAN) interface to form a network;
enabling a VLAN Class Of Service (COS) and differentiated service code point in a priority tag of a message transmitted in the network to correspond to each other;
in response to layer-3 forwarding of the message, using the differentiated service code point in the priority tag for the message, and copying a VLAN COS value of the message at an entry of a switch to a VLAN COS value of the message at an exit; and
in response to subsequent layer-2 forwarding of the message, using the VLAN COS in the priority tag for the message to distinguish a priority of the message.

2. The method according to claim 1, wherein the enabling a VLAN COS and differentiated service code point in a priority tag of a message transmitted in the network to correspond to each other comprises:
enabling fields 0 to 7 of the VLAN COS to correspond to fields 0 to 63 of the differentiated service code point respectively, wherein one field of the VLAN COS corresponds to eight fields of the differentiated service code point.

3. The method according to claim 2, wherein fields of the VLAN COS and the differentiated service code point increase with increase of a priority of service of quality in the message.

4. The method according to claim 1, wherein the performing networking by using a VLAN interface comprises:
performing networking in a convergence layer and core layer of an enterprise by using the VLAN interface.

5. The method according to claim 1, wherein the message contains a VLAN tag when sent out by the VLAN interface.

6. A device for forwarding a priority tag across network segments, comprising:
at least one processor; and
a memory, having a program code executable by the at least one processor stored thereon, which when executed by the at least one processor, causes the at least one processor to implement the following steps:
enabling a VLAN Class Of Service (COS) and differentiated service code point in a priority tag of a message transmitted in a network formed by performing networking by using a Virtual Local Area Network (VLAN) interface to correspond to each other;
in response to layer-3 forwarding of the message, using the differentiated service code point in the priority tag for the message, and copying a VLAN COS value of the message at an entry of a switch to a VLAN COS value of the message at an exit; and
in response to subsequent layer-2 forwarding of the message, using the VLAN COS in the priority tag for the message to distinguish a priority of the message.

7. The device according to claim 6, wherein the enabling a VLAN COS and differentiated service code point in a priority tag of a message transmitted in the network to correspond to each other comprises:
enabling fields 0 to 7 of the VLAN COS to correspond to fields 0 to 63 of the differentiated service code point respectively, wherein one field of the VLAN COS corresponds to eight fields of the differentiated service code point.

8. The device according to claim 7, wherein fields of the VLAN COS and the differentiated service code point increase with increase of a priority of service of quality in the message.

9. The device according to claim 6, wherein the performing networking by using a VLAN interface comprises:
performing networking in a convergence layer and core layer of an enterprise by using the VLAN interface.

10. The device according to claim 6, wherein the message contains a VLAN tag when sent out by the VLAN interface.

11. A non-transitory computer-readable storage medium, having computer-readable instructions stored thereon which, when executed by a processor, implement the following steps:
enabling a VLAN Class Of Service (COS) and differentiated service code point in a priority tag of a message transmitted in a network formed by performing networking by using a Virtual Local Area Network (VLAN) interface to correspond to each other;
in response to layer-3 forwarding of the message, using the differentiated service code point in the priority tag for the message, and copying a VLAN COS value of the message at an entry of a switch to a VLAN COS value of the message at an exit; and
in response to subsequent layer-2 forwarding of the message, using the VLAN COS in the priority tag for the message to distinguish a priority of the message.

12. The method according to claim 1, further comprising:
enabling a VLAN COS for layer-2 transmission to correspond to a differentiated service code point for layer-3 transmission such that a priority of quality of service in the message remains consistent during layer-2 transmission or layer-3 transmission.

13. The method according to claim 1, further comprising:
copying a VLAN COS field in the message received at the entry of the switch to a VLAN COS field at the exit.

14. The device according to claim 6, wherein the processor is further caused to implement the following step:
enabling a VLAN COS for layer-2 transmission to correspond to a differentiated service code point for layer-3 transmission such that a priority of quality of service in the message remains consistent during layer-2 transmission or layer-3 transmission.

15. The device according to claim 6, wherein the processor is further caused to implement the following step:
copying a VLAN COS field in the message received at the entry of the switch to a VLAN COS field at the exit.

16. The non-transitory computer-readable storage medium according to claim 11, wherein the enabling a VLAN COS and differentiated service code point in a priority tag of a message transmitted in the network to correspond to each other comprises:
enabling fields 0 to 7 of the VLAN COS to correspond to fields 0 to 63 of the differentiated service code point respectively, wherein one field of the VLAN COS corresponds to eight fields of the differentiated service code point.

17. The non-transitory computer-readable storage medium according to claim 16, wherein fields of the VLAN COS and the differentiated service code point increase with increase of a priority of service of quality in the message.

18. The non-transitory computer-readable storage medium according to claim 11, wherein the performing networking by using a VLAN interface comprises:
performing networking in a convergence layer and core layer of an enterprise by using the VLAN interface.

19. The non-transitory computer-readable storage medium according to claim 11, wherein the message contains a VLAN tag when sent out by the VLAN interface.

20. The non-transitory computer-readable storage medium according to claim 11, wherein the computer-readable instructions, when executed by the processor, further implement the following step:
enabling a VLAN COS for layer-2 transmission to correspond to a differentiated service code point for layer-3 transmission such that a priority of quality of service in the message remains consistent during layer-2 transmission or layer-3 transmission.
